(19) United States
(12) Patent Application Publication
(10) Pub. No.: US 2026/0170708 A1
(43) Pub. Date: Jun. 18, 2026

(54) INFORMATION PROCESSING DEVICE

(71) Applicant: TOYOTA JIDOSHA KABUSHIKI KAISHA, Toyota-shi (JP)

(72) Inventor: Satoshi MIYAKE, Toyota-shi (JP)

(73) Assignee: TOYOTA JIDOSHA KABUSHIKI KAISHA, Toyota-shi (JP)

(21) Appl. No.: 19/404,142

(22) Filed: Dec. 1, 2025

(30) Foreign Application Priority Data
Dec. 16, 2024 (JP) 2024-220185

(51) Int. Cl. G06T 11/00

(52) U.S. Cl. CPC G06T 11/00

(57) ABSTRACT

An information processing device includes: a first generator configured to generate, based on graph information related to a plurality of graph structures respectively generated based on a plurality of pieces of image data stored in a database (DB), a new graph structure such that a deviation amount of the new graph structure from the graph structures is greater than or equal to a first predetermined value; and a second generator configured to generate new image data based on the new graph structure.

### CROSS-REFERENCE TO RELATED APPLICATION

This application claims priority to Japanese Patent Application No. 2024-220185 filed on Dec. 16, 2024. The disclosure of the above-identified application, including the specification, drawings, and claims, is incorporated by reference herein in its entirety.

### BACKGROUND

### 1. Technical Field

The present disclosure relates to the technical field of information processing devices.

### 2. Description of Related Art

As an example of this type of system, a system has been proposed in which a large language model (LLM) is used to generate query data based on documents, and pairs of the documents and the query data are used to train a retrieval model for a dialogue bot (see Japanese Unexamined Patent Application Publication No. 2023-076413 (JP 2023-076413 A)).

### SUMMARY

The term “large language model” refers to a language model constructed using extremely large datasets and deep learning techniques. In some cases, it is difficult to collect a large volume of data (i.e., training data) to be used for training such a model. To address this, a technique called data augmentation has been proposed, which artificially generates new data by applying modifications to existing data. However, when such modifications are manually set, the human workload is relatively high.

The present disclosure has been made in view of the above circumstances, and an object thereof is to provide an information processing device capable of generating new data.

An information processing device according to an aspect of the present disclosure includes: a first generator configured to generate, based on graph information related to a plurality of graph structures respectively generated based on a plurality of pieces of image data stored in a database, a new graph structure such that a deviation amount of the new graph structure from the graph structures is greater than or equal to a first predetermined value; and a second generator configured to generate new image data based on the new graph structure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an example of the configuration of an information processing device according to an embodiment;

FIG. 2 is a block diagram illustrating an example of the configuration of a computation device according to the embodiment; and

FIG. 3 is a conceptual diagram illustrating an operational concept of the information processing device according to the embodiment.

### DETAILED DESCRIPTION OF EMBODIMENTS

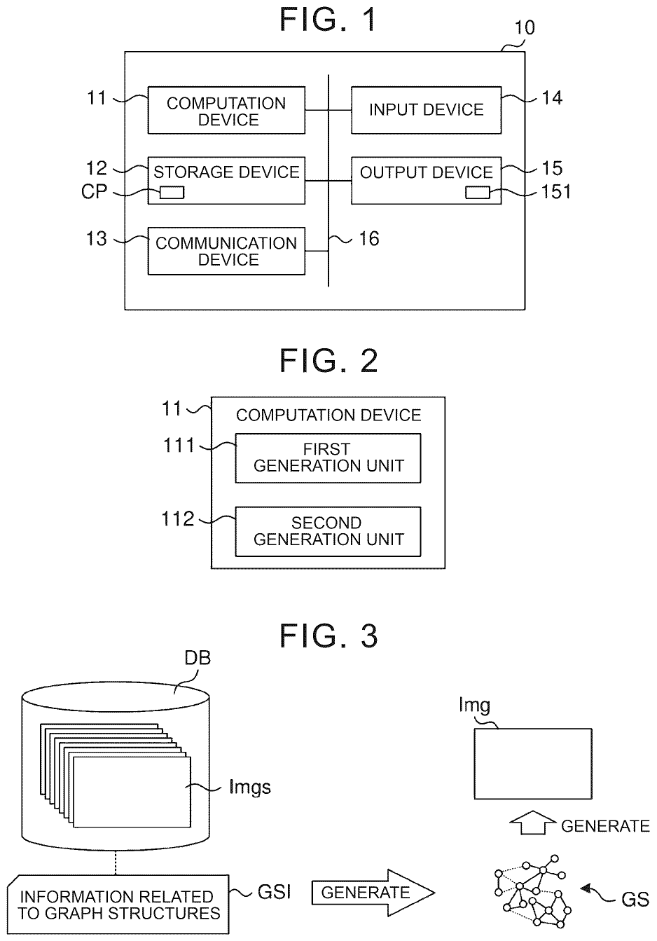

An embodiment of an information processing device will be described with reference to FIGS. 1 to 3. In FIG. 1, the information processing device 10 includes a computation device 11, a storage device 12, a communication device 13, an input device 14, and an output device 15. The computation device 11, the storage device 12, the communication device 13, the input device 14, and the output device 15 are connected via a data bus 16.

The computation device 11 may include a processor. The computation device 11 may include a single processor or a plurality of processors. In other words, the computation device 11 may include one or more processors. The processor may be a multi-core processor. When the computation device 11 includes a single processor that is a multi-core processor, the computation device 11 may be regarded as logically including a plurality of processors.

The processor may be, for example, at least one of the following: a central processing unit (CPU), a graphics processing unit (GPU), a field programmable gate array (FPGA), and a tensor processing unit (TPU).

The storage device 12 may be, for example, at least one of the following: a random access memory (RAM), a read-only memory (ROM), a hard disk drive, a magneto-optical disk drive, a solid-state drive (SSD), and an optical disk array. That is, the storage device 12 may be implemented using a single device or a plurality of devices.

The communication device 13 may be capable of communicating with a device external to the information processing device 10. The communication device 13 may perform wired communication or wireless communication.

The input device 14 is a device capable of receiving input of information into the information processing device 10 from outside. The input device 14 may include an operation device operable by a user of the information processing device 10 (e.g., a keyboard, a mouse, a touch panel, etc.). The input device 14 may include a recording medium reader capable of reading information recorded on a recording medium (such as a Universal Serial Bus (USB) memory) that is attachable to and detachable from the information processing device 10. When information is input to the information processing device 10 via the communication device 13 (in other words, when the information processing device 10 acquires information via the communication device 13), the communication device 13 may serve as an input device.

The output device 15 is a device capable of outputting information to the outside of the information processing device 10. The output device 15 may include a display device 151 capable of outputting visual information such as text or images as the output information. The output device 15 may include a speaker capable of outputting auditory information such as sound as the output information. The output device 15 may include a vibration motor capable of outputting tactile information such as vibration as the output information. The output device 15 may include a printer. The output device 15 may be capable of outputting information to a recording medium that is attachable to and detachable from the information processing device 10, such as a USB memory. When the information processing device 10 outputs information via the communication device 13, the communication device 13 may serve as an output device.

The storage device 12 is capable of storing desired data. The storage device 12 may store a computer program CP that is executed by the computation device 11. When the computation device 11 is executing the computer program CP, the storage device 12 may temporarily store data temporarily used by the computation device 11.

The computer program CP may be recorded on a computer-readable and non-transitory recording medium. In this case, the computer program CP may be stored in the storage device 12 by reading the recording medium using a recording medium reader (not shown) included in the information processing device 10. At least one of the following media may be used as the recording medium: an optical disk, a magnetic medium, a magneto-optical disk, a semiconductor memory, and any other medium capable of storing programs. The computer program CP may be acquired from a device (not shown) external to the information processing device 10 via the communication device 13. In other words, the computer program CP may be downloaded from an external device to the storage device 12 of the information processing device 10.

The computation device 11 (e.g., a processor), together with the storage device 12 storing the computer program CP (in other words, together with the storage device 12 and the computer program CP stored in the storage device 12), may execute processing to be performed by the information processing device 10. For example, logical functional blocks for executing the processing to be performed by the information processing device 10 may be implemented within the computation device 11 (e.g., within the processor) by the computation device 11 executing the computer program CP.

As shown in FIG. 2, the computation device 11 includes a first generation unit 111 and a second generation unit 112. The first generation unit 111 and the second generation unit 112 may be implemented as the logical functional blocks described above. However, either or both of the first generation unit 111 and the second generation unit 112 may be implemented as a physical processing circuit. Alternatively, either or both of the first generation unit 111 and the second generation unit 112 may be implemented as a combination of a logical functional block and a physical processing circuit.

The operation of the information processing device 10 configured as described above will now be described with reference to FIG. 3. In FIG. 3, a plurality of pieces of image data Imgs is stored in a database DB. It is assumed that, for a plurality of pieces of image data Imgs, there is graph information GSI related to a plurality of graph structures respectively generated based on the pieces of image data Imgs. The graph information GSI may be information indicating the graph structures themselves, or may be information indicating feature vectors obtained by vectorizing each of the graph structures. Alternatively, the graph information GSI may be a distribution map indicating the distribution, in feature space, of a plurality of features associated with the graph structures.

The graph information GSI may be stored in the database DB, or may be stored in a device different from the database DB. The graph structure may refer to data including a group of nodes representing the relationships among parts of objects within an image corresponding to one piece of image data, and a group of edges representing relationships between the nodes. Various existing methods can be applied as methods for generating a graph structure from image data. Accordingly, a detailed description of how to generate a graph structure from image data will be omitted. The features associated with the graph structure may be calculated using a trained model (e.g., a graph neural network (GNN)). The “features associated with the graph structure” may include features related to the entire graph structure, or features related to each component (i.e., node) included in the graph structure.

The information processing device 10 may perform the processing described below to generate new image data (e.g., image data Img) using a plurality of pieces of image data Imgs stored in the database DB.

The first generation unit 111 of the information processing device 10 may generate, based on the graph information GSI, a new graph structure (e.g., graph structure GS) such that a deviation amount of the new graph structure from the graph structures corresponding to the pieces of image data Imgs is greater than or equal to a first predetermined value. The first generation unit 111 may generate, based on the graph information GSI, a new graph structure such that a deviation amount of the new graph structure from the graph structures is greater than or equal to the first predetermined value and less than a second predetermined value.

For example, the first generation unit 111 may determine (or estimate) the deviation amount by calculating a distance between each of the graph structures and a candidate for the new graph structure. Alternatively, the first generation unit 111 may determine (or estimate) the deviation amount based on the feature vectors corresponding to the graph structures and the feature vector corresponding to the candidate for the new graph structure. Alternatively, the first generation unit 111 may determine (or estimate) the deviation amount based on at least one of the type, positional relationship, shape, and color of the objects in each of the graph structures and at least one of the type, positional relationship, shape, and color of the objects in the candidate for the new graph structure.

For example, when the graph information GSI is the distribution map described above, the first generation unit 111 may generate a new graph structure including components corresponding to blank regions (i.e., regions where no data points representing features are present) of the distribution map. In this case, the first generation unit 111 may determine (or estimate) the deviation amount using any of the methods described above. Since the first generation unit 111 generates a new graph structure, the first generation unit 111 may also be referred to as graph structure generation means or structure generation means.

For example, when a dataset used for model training contains a large number of similar data items, the data distribution may become biased, resulting in a decrease in the quality of the dataset. In the present embodiment, in order to suppress such a decrease in quality, the first generation unit 111 may generate a new graph structure such that a deviation amount of the new graph structure from the graph structures corresponding to the pieces of image data Imgs is greater than or equal to a first predetermined value. In other words, the first predetermined value can be regarded as a value for suppressing bias in the data distribution within the dataset. The first predetermined value may be a fixed value, or may be a variable value depending on some parameter.

For example, if a dataset used for model training contains a relatively large number of outliers or anomalies, the accuracy of a model trained using the dataset may be relatively low. In the present embodiment, in order to suppress the generation of outliers and anomalies, the first generation unit 111 may generate a new graph structure such that a deviation amount of the new graph structure from the graph structures corresponding to the pieces of image data Imgs is less than a second predetermined value. In other words, the second predetermined value can be regarded as a value for suppressing the generation of outliers and anomalies. The second predetermined value may be a fixed value, or may be a variable value depending on some parameter.

The second generation unit 112 of the information processing device 10 may generate new image data (e.g., image data Img) based on a new graph structure (e.g., graph structure GS) generated by the first generation unit 111. In other words, the second generation unit 112 may generate new image data such that a graph structure generated based on the new image data becomes the new graph structure generated by the first generation unit 111. The second generation unit 112 may generate new image data using a trained model (e.g., an image generation artificial intelligence (AI)) that, upon receiving the new graph structure generated by the first generation unit 111 as input, generates image data. Since the second generation unit 112 generates new image data, the second generation unit 112 may also be referred to as image generation means.

The computation device 11 of the information processing device 10 may store the new image data (e.g., image data Img) generated by the second generation unit 112 in the database DB. The computation device 11 of the information processing device 10 may also control the display device 151 to display an image corresponding to the new image data (e.g., image data Img) generated by the second generation unit 112. The user of the information processing device 10 may, via the input device 14, instruct whether to store in the database 40 the image data corresponding to the image displayed on the display device 151.

### Technical Effects

In the present embodiment, the first generation unit 111 generates a new graph structure based on the graph information GSI. The second generation unit 112 generates new image data based on the generated new graph structure. That is, the information processing device 10 according to the present embodiment can generate new image data. In the present embodiment, the information processing device 10 automatically generates new image data based on the graph information GSI. Therefore, the information processing device 10 can reduce human workload.

Aspects of the disclosure derived from the above embodiment will be described below.

An information processing device according to an aspect of the present disclosure includes: a first generator configured to generate, based on graph information related to a plurality of graph structures respectively generated based on a plurality of pieces of image data stored in a database, a new graph structure such that a deviation amount of the new graph structure from the graph structures is greater than or equal to a first predetermined value; and a second generator configured to generate new image data based on the new graph structure. In the above embodiment, the “first generation unit 111” is an example of the “first generator,” and the “second generation unit 112” is an example of the “second generator.”

In the information processing device according to the above aspect, the graph information may be a distribution map in which a distribution of the graph structures is mapped, and the first generator may be configured to generate, as the new graph structure, a graph structure including a component corresponding to a blank region in the distribution map. With this configuration, it is possible to relatively easily generate image data that is different from the pieces of image data already stored in the database.

In the information processing device according to the above aspect, the first generator may be configured to generate, based on the graph information, the new graph structure such that the deviation amount is greater than or equal to the first predetermined value and less than a second predetermined value. With this configuration, it is possible to suppress generation of image data corresponding to outliers or anomalies.

In the information processing device relating to the above aspect, the graph information may include information indicating at least one of a type, positional relationship, shape, and color of an object in the graph structure, and the first generator may be configured to determine the deviation amount based on the at least one of a type, positional relationship, shape, and color of an object in the graph structure. With this configuration, it is possible to relatively easily determine the deviation amount.

The present disclosure is not limited to the embodiment described above, and various modifications can be made as appropriate without departing from the gist or spirit of the disclosure as understood from the claims and the entire specification. Information processing devices incorporating such modifications are also within the technical scope of the present disclosure.

What is claimed is:

1. An information processing device comprising:
a first generator configured to generate, based on graph information related to a plurality of graph structures respectively generated based on a plurality of pieces of image data stored in a database, a new graph structure such that a deviation amount of the new graph structure from the graph structures is greater than or equal to a first predetermined value; and
a second generator configured to generate new image data based on the new graph structure.

2. The information processing device according to claim 1, wherein:
the graph information is a distribution map in which a distribution of the graph structures is mapped; and
the first generator is configured to generate, as the new graph structure, a graph structure including a component corresponding to a blank region in the distribution map.

3. The information processing device according to claim 1, wherein the first generator is configured to generate, based on the graph information, the new graph structure such that the deviation amount is greater than or equal to the first predetermined value and less than a second predetermined value.

4. The information processing device according to claim 1, wherein:
the graph information includes information indicating at least one of a type, positional relationship, shape, and color of an object in the graph structure; and
the first generator is configured to determine the deviation amount based on the at least one of a type, positional relationship, shape, and color of an object in the graph structure.
